(19) United States
(12) Patent Application Publication
(10) Pub. No.: US 2009/0172914 A1
(43) Pub. Date: Jul. 9, 2009

(54) DEVICE FOR PRESSURE CLEARING OF PASSAGEWAYS

(76) Inventor: Moshe Kadesh, Kiriat Ata (IL)

Correspondence Address: YORAM TSIVION, P.O. BOX 1307, PARDES HANNA, 37111, IL

(21) Appl. No.: 10/596,645

(22) PCT Filed: Dec. 21, 2004
(86) PCT No.: PCT/IL04/01151

§ 371 Date: Jun. 20, 2006

(51) Int. Cl. B08B 9/02

(52) U.S. Cl. 15/406

(57) ABSTRACT

A device for clearing of fluid or gas passageways. The device uses a first cylinder having an external thread, and an internal piston. Another cylinder has an internal thread for screwing on the thread of the first cylinder for forcing the piston through the first cylinder. The first cylinder extrudes gas or liquid under pressure.

### TECHNICAL FIELD OF THE INVENTION

The present invention relates to maintenance of mechanical systems employing pressure passages. More specifically the invention is a device for clearing and cleaning water passages, hydraulic and pneumatic passageways in technical gear and infrastructure.

### BACKGROUND OF THE INVENTION

Mechanical devices employing pneumatic or hydraulic parts utilize pressurized gases or liquids for affecting force and torque on working objects. The pressurized gases or liquids activate linear or rotational gear that exerts a mechanical effect on the target objects. Such equipment as for example presses, grinders, cutters and mills require free passage of the liquids, as the mechanical design dictates, in order to effectively run the equipment in specified conditions. Some other technical applications are not involved in mechanical reforming of objects, but rather employ non pressurized or slightly pressurized redirection of fluids, such are typically draining systems such as air conditioning, irrigation and sewage.

A major tool in the dentist's art is a set of hand-pieces used for drilling, cleaning and treating the teeth and gums of the patient. Air driven drilling hand-pieces typically contain an air driven turbine which drives the drill bit that drills into the tooth or bone. The hand-piece that is held by the dentist during drilling or otherwise treating of a patient. Typically, a dentist stores several hand-pieces which are easily interchangeable due to a quick release connection. The debris formed in the operation of the drill is driven away from the drilling site by a jet of water aimed at the site of drilling. The water jet also cools the teeth and drill in the course of treatment, preventing heat damages affecting the tooth. The water passages in the hand-piece are susceptible of blockage by precipitated salts, and organic matter. The connectors, also known as couplers, that connect the hand piece to the tubing of the treatment unit are also susceptible of blockage in their water passages.

Since water passages obstructions are harmful in respect of the fact that they prevent cooling and debris removal in the course of drilling, and hinder achieving proper sterilization of the hand-piece, periodic or ad hoc treatments of the water passages of the hand-pieces and coupler are implemented.

### BRIEF DESCRIPTION OF THE DRAWINGS

FIG. 1A is a schematic side view of a clearing device of the invention;

FIG. 1B is a schematic side view of a clearing device of the invention in which a tightening member is shown screwed on the piston, showing a part of the thread enveloping the cylinder;

FIG. 2 is a schematic sectional view of a clearing device of the invention showing fluid driving mechanism;

FIG. 3A is a schematic isometric view of a flushing device of the invention without a tightening member at a position prior to coupling to a dentist's hand-piece;

FIG. 3B is a schematic isometric view of a flushing device of the invention without a tightening member, coupled to a dentist's hand-piece.

### DETAILED DESCRIPTION OF THE PRESENT INVENTION

The embodiments of the present invention are pressurizing devices for clearing passageways of gasses or liquids by building up pressure that clears the obstructed passageway. The pressure provided by the device of the invention may be used in conjunction with an auxiliary clearing agent, such as cleansing liquid or a solvent, or a gas.

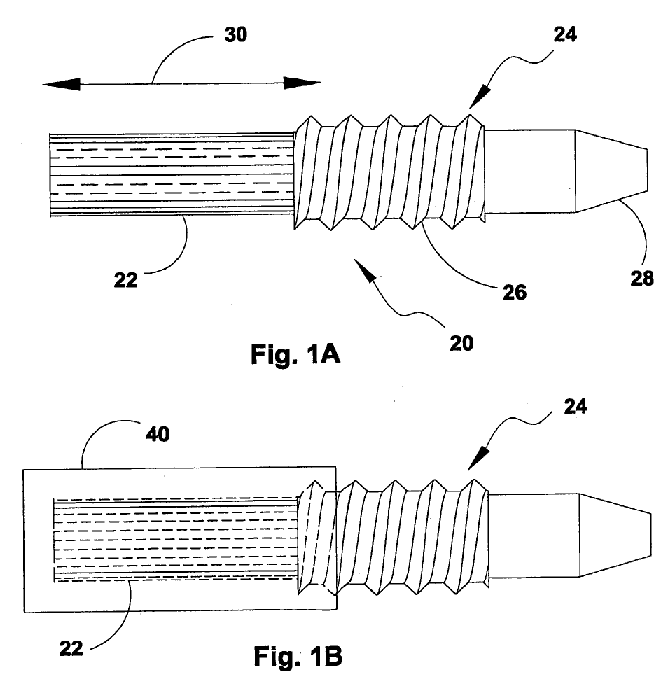

A specific implementation of the device of the invention is in the clearing of the water passages of a hand-piece of a dentist. The instruments are cleared periodically, or on demand, by pressurizing cleansing liquid trough them. In order to flush a hand-piece, it is detached from the treatment unit. A clearing device of the invention is connected to the hand-piece by its coupler, typically a Midwest 6-hole coupler. A flushing device of the invention is described schematically in FIGS. 1A and 1B to which reference is now made. In FIG. 1A a flushing device of the invention generally designated 20 contains a piston 22 inserted in cylinder 24. In a preferred embodiment of the present invention the cylinder bears at least on a part of its outer surface a screw thread 26. At the right end of cylinder 24 is connected a coupler 28. Functionally, piston 22 can move in the direction of double headed arrow 30. As the piston moves inside cylinder 25, it pressurizes a clearing liquid inside this cylinder, which can then effectively clear water passages in a hand-piece (not shown), connected to coupler 28.

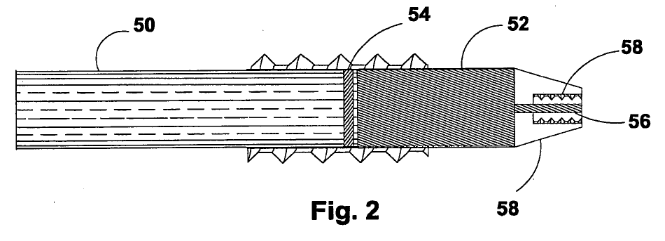

In FIG. 1B another feature of the present invention is described. A tightening member 40, is a typically a cylindrical component having an internal screw thread (not shown) that fits with the external screw thread 26. By turning the tightening member 40 in one direction, the piston 22 is pressed inside the cylinder 26. As the cylinder is pushed into the cylinder, the clearing fluid stored in the cylinder is pressurized out of the cylinder into the coupler 28 and to the hand-piece (not shown). The mechanism for driving of the cleansing fluid into the hand-piece is described in reference to FIG. 2. Piston 50 pushes into cylinder 52, pressing the liquid in the cylinder. A gasket 54 prevents the backflow of the fluid in the direction of the piston. Fluid channel 56 traversing the coupler 58 transfers pressurized cleansing liquid into the hand-piece, or to a coupler, or to an adapter thereof (not shown). The hand piece is connected by screwing to internal screw thread 60, directly or by an adaptor.

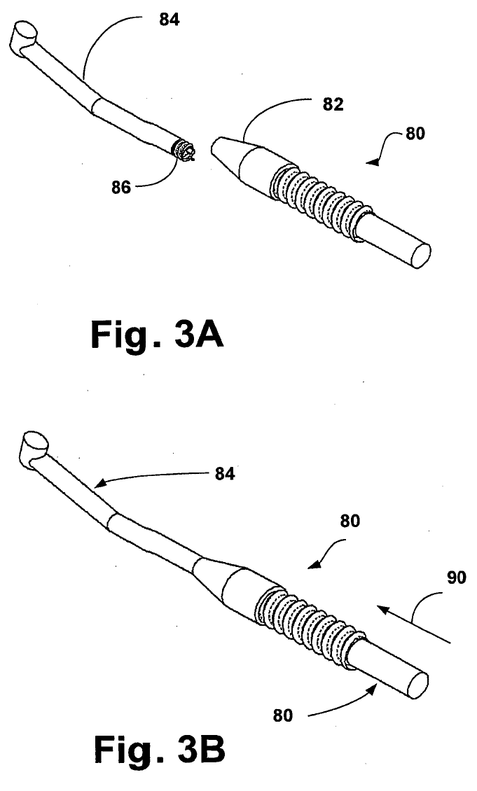

A schematic isometric view of a flushing device of the invention is shown in FIG. 3A to which reference is now made. The flushing device 80, which is shown without a tightening member is shown such that its coupler 82 faces a hand piece 84 having an external screw thread 86 of it coupler at its coupling end. In FIG. 3B the flushing device 80 is shown connected to the hand-piece 84. Piston 88 is now ready to be pushed in the direction of arrow 90, for cleansing the water passages of the hand-piece.

In another embodiment of the invention, the piston is outwardly screw-threaded such that the tightening is effected by turning the piston against a complementary screw thread associated with a part of the inner face of the cylinder.

The implementations of the invention are in maintaining various types of appliances in which gas and liquid passages are to be kept clear of obstructions. Referring to FIGS. 1A and 1B, the coupler 28 is used for connecting the device of the invention to the treated devices. For pressure coupling. or for other coupling, the coupler is threaded on the inside or on the outside or both, using a standard thread of the art. However any kind of intermediate coupling can be used to connect the appliance to be maintained with the pressure building device of the invention. The piston may be used to pressurize a liquid, such as water or acid, or a gas such as air or inert gas.

Uses for the pressurizing device of the invention are in various technical field. Vehicle maintenance uses are for clearing fuel passageways, cooling water passageways and water sprinklers. In the printing field, use is for cleaning ink passageways and for inkjets and nozzles. For medical appliances the system of the invention is used for clearing fluid passageways. Obstructions to pneumatic gear using pressurized liquid for powering mechanical equipment, can be cleared using the system of the invention by applying pressurized clearing gas or liquids. In air conditioning, clogged drainage passageways can be cleared by using the system of the invention. Likewise, water installations and sewage system can use the system of the invention for clearing clogs. As mentioned above, the system of the invention can be used for clearing passageways of non pressurized or slightly pressurised flow of liquids such as in oil channels in mechanical appliances.

The system of the invention may be manufactured from metal or from plastic parts, or from any other suitable material which my withstand pressure and chemical effect of the clearing agent.

1. A pressurising device for clearing of passageways of liquids and fluids comprising:
a piston for pressurizing a clearing agent;
a cylinder for containing said clearing agent, and
a coupler for connecting said cylinder to a treated device.

2. A pressurising device for clearing of passageways as in claim 1 and wherein at least a part of the external surface of said cylinder is threaded for applying a tightening member for tightening said piston.

3. A pressurising device as in claim 1 for flushing a hand-piece of a dentist, comprising:
a piston for pressurizing a cleansing fluid;
a cylinder for containing said cleansing fluid, and
a coupler for connecting said cylinder to a coupler of said hand-piece.

4. A pressurising device as in claim 3 and wherein at least a part of the external surface of said cylinder is threaded for applying a tightening member for tightening said piston.

5. A pressurising device for clearing of passageways as in claim 1 for clearing pneumatic system.

6. A pressurising device for clearing of passageways as in claim 1 for clearing hydraulic systems.
